(19) United States
(12) Patent Application Publication
(10) Pub. No.: US 2025/0309727 A1
(43) Pub. Date: Oct. 2, 2025

(54) MOTOR AND ELECTRICAL PRODUCT

(71) Applicant: NIDEC CORPORATION, Kyoto (JP)

(72) Inventors: Yan WANG, Dalian (CN); Lijun BU, Dalian (CN)

(21) Appl. No.: 19/092,190

(22) Filed: Mar. 27, 2025

(30) Foreign Application Priority Data
Mar. 29, 2024 (CN) 202410375187.7

(51) Int. Cl. H02K 5/22

(52) U.S. Cl. CPC H02K 5/225

(57) ABSTRACT

A motor includes a rotor including a rotating shaft rotatable around a central axis, a stator radially opposed to the rotor, a housing that accommodates the rotor and the stator, and a connector that is inserted and fixed to the housing and is connected to a busbar in a radial direction. The connector includes at least two support portions. The at least two support portions are respectively located on two sides of the connector, and are respectively connected and fixed to a side wall and a bottom surface of the housing in an axial direction. The support portions support and fix the connector from the sides, and prevent the connector from being subjected to a force of the busbar towards the radially inner side to prevent the connector from tilting inward.

### CROSS REFERENCE TO RELATED APPLICATION

The present application claims priority under 35 U.S.C. § 119 to Chinese Application No. 202410375187.7, filed on Mar. 29, 2024, the entire contents of which are hereby incorporated herein by reference.

### 1. FIELD OF THE INVENTION

The present application relates to the electromechanical field, and more particularly to motors and electrical products.

### 2. BACKGROUND

In order to realize the connection between a motor and external electronic components, a connector is usually inserted into a housing, and the connection between a busbar inside the housing of the motor and various external electronic components is completed through the connector.

It should be noted that the above introduction to the technical background is only for the purpose of clearly and completely describing the example embodiments and technical solutions of the present application and facilitating the understanding of those skilled in the art. It cannot be considered that the above technical solutions are well known to those skilled in the art simply because these solutions have been described in the background section of the present application.

### SUMMARY

The inventors have discovered that, in the prior art, in order to fix the connector on the motor housing, a support portion is provided at the bottom of the connector, and the positioning of the connector is realized by the interference fit between the support portion and the housing, and the connector and the busbar are connected by radial clamping and welding. However, after welding, the busbar will generate a radial pulling force on the connector, which in turn causes the connector to tilt radially inward, resulting in lower stability of the connector.

In view of the above problems, the example embodiments of the present application provide motors and electrical products. With a motor provided by an example embodiments of the present application, the support portions support and fix the connector from the sides, which can prevent the connector from being subjected to the force of the busbar towards the radially inner side to prevent the connector from tilting inward.

According to a first example embodiment of the present application, a motor includes a rotor including a rotating shaft rotatable around a central axis, a stator that is radially opposed to the rotor, a housing that accommodates the rotor and the stator, and a connector that is inserted and fixed to the housing and is connected to a busbar in a radial direction. The connector includes at least two support portions respectively located on two sides of the connector and respectively connected and fixed to a side wall and a bottom surface of the housing in an axial direction.

According to a second example embodiment of the present application, the at least two support portions are located on a radially outer side of a side wall of the connector.

According to a third example embodiment of the present application, a length of the at least two support portions in the axial direction is greater than or equal to a length of the side wall of the housing.

According to a fourth example embodiment of the present application, one end of the at least two support portions in the axial direction is parallel to or higher than the side wall of the housing, and the other end extends toward the bottom surface of the housing and protrudes from a bottom of the connector.

According to a fifth example embodiment of the present application, a diameter of the at least two support portions is greater than about 20% of a planar length where the at least two support portions are located.

According to a sixth example embodiment of the present application, a cross-sectional shape of the portion of the at least two support portions inserted into the bottom surface of the housing is semicircular.

According to a seventh example embodiment of the present application, a circumferential outer surface of the at least two support portions has at least one rib.

According to an eighth example embodiment of the present application, a bottom of the connector also includes a bottom support portion, and the bottom support portion is not on a same straight line as the support portions located on two sides of the connector.

According to a ninth example embodiment of the present application, the at least two support portions and the connector are integrally provided portions of a single monolithic structure.

According to a tenth example embodiment of the present application, there is provided an electrical product including a motor according to any one of the first to ninth example embodiments described above.

One of the beneficial effects of the example embodiments of the present application is that, with the motors provided by the example embodiments of the present application, the support portions support and fix the connector from the sides to prevent the connector from being subjected to the force of the busbar towards the radially inner side, and to prevent the connector from tilting inward and improve the stability of the connector.

The specific example embodiments of the present application are disclosed in detail below with reference to the following description and drawings, which indicate the ways in which the principles of the present application may be used. It should be understood that the example embodiments of the present application are not limited in scope. The example embodiments of the present application include many changes, modifications, and equivalents within the scope of the appended claims.

Features described and/or illustrated with respect to one example embodiment may be used in the same or similar way in one or more other example embodiments, in combination with features in other example embodiments, or in place of features in other example embodiments.

It should be emphasized that the term “comprising/including” when used herein refers to the presence of a feature, an entirety, a step, or a component, but does not exclude the presence or addition of one or more other features, entireties, steps, or components.

The above and other elements, features, steps, characteristics and advantages of the present disclosure will become more apparent from the following detailed description of the example embodiments with reference to the attached drawings.

### BRIEF DESCRIPTION OF THE DRAWINGS

The elements and features described in one drawing or one example embodiment of the present application may be combined with the elements and features shown in one or more other drawings or example embodiments. Furthermore, in the drawings, like reference numerals denote corresponding parts throughout the several views and may be used to indicate corresponding parts used in more than one example embodiment.

The included drawings are provided to provide a further understanding of the example embodiments of the present application, define a portion of the description, are used to illustrate the example embodiments of the present application, and are used to explain the principles of the present application together with the written description. The drawings referred to in the following description are only some example embodiments of the present application.

FIG. 1 is a cross-sectional view of a motor according to an example embodiment of the present application.

FIG. 2 is a schematic diagram of a connector of a motor according to an example embodiment of the present application.

FIG. 3 is a schematic diagram of a housing of a motor according to an example embodiment of the present application.

FIG. 4 is a schematic diagram of a connector of a motor according to an example embodiment of the present application inserted into the housing.

FIG. 5 is another schematic diagram of a connector of a motor according to an example embodiment of the present application inserted into the housing.

FIG. 6 is a cross-sectional view of a connector of a motor according to an example embodiment of the present application.

FIG. 7 is another schematic diagram of a connector of a motor according to an example embodiment of the present application.

FIG. 8 is another schematic diagram of a connector of a motor according to an example embodiment of the present application.

### DETAILED DESCRIPTION

Referring to the drawings, the foregoing and other features of the present application will become apparent through the following description. In the description and drawings, specific example embodiments of the present application are specifically disclosed, which indicate some example embodiments in which the principles of the present application may be employed. It should be understood that the present application is not limited to the described example embodiments. On the contrary, the present application includes all modifications, variations, and equivalents falling within the scope of the appended claims. The various example embodiments of the present application will be described below with reference to the drawings. These example embodiments are merely exemplary and are not intended to limit the present application.

In the example embodiments of the present application, terms such as “first”, “second”, “upper”, “lower” are used to distinguish different elements from appellations, but do not indicate the spatial arrangement or temporal order of these elements, and these elements should not be limited by these terms. The term “and/or” includes any one and all combinations of one or more of the associated listed terms. The terms “comprise”, “include”, “have”, etc. refer to the existence of the stated features, elements, components, or assemblies, but do not preclude the presence or addition of one or more other features, elements, components, or assemblies.

In the example embodiments of the present application, the singular forms “a”, “the”, etc. include the plural forms, and should be understood broadly as “a kind of” or “a class” rather than being limited to the meaning of “one”; in addition, the term “the” should be understood to include both the singular and plural forms, unless the context clearly dictates otherwise. In addition, the term “according to” should be understood as “at least partially according to . . . ”, and the term “based on” should be understood as “at least partially based on . . . ”, unless the context clearly dictates otherwise.

In addition, in the following description of the example embodiments of the present application, for convenience of explanation, the direction extending along the central axis of the motor or the direction parallel thereto is referred to as “axial direction”, the radial direction centered on the central axis is referred to as “radial direction”, the direction surrounding the central axis is referred to as “circumferential direction”, the side away from the central axis along the radial direction is referred to as “radially outer side”, the side close to the central axis along the radial direction is referred to as “radially inner side”, the direction from the bottom of the motor housing to the opening is referred to as “upper”, “axially upper”, “upper side” or “axially upper side”, and the direction from the opening of the motor housing to the bottom of the motor housing is referred to as “lower”, “axially lower”, “lower side” or “axially lower side”. However, it should be noted that these are only for convenience of explanation, and do not limit the orientation of the motor during use and manufacture.

The example embodiments of the present application will be described below with reference to the drawings.

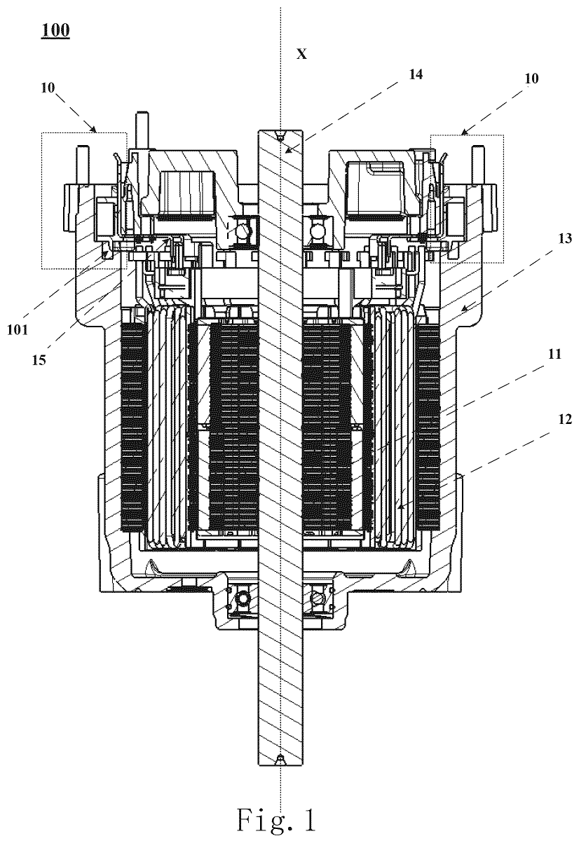

An example embodiment the present application provides a motor 100. FIG. 1 is a cross-sectional view of the motor 100 provided by the example embodiment of the present application. As shown in FIG. 1, the motor 100 includes: a rotor 11, a stator 12, and a housing 13. Wherein, the rotor 11 has a rotating shaft 14 that rotates around a central axis X, the stator 12 is radially opposed to the rotor 11, and both the rotor 11 and the stator 12 are accommodated in the housing 13.

In addition, as shown in FIG. 1, the motor 100 also has a connector 10. The connector 10 is inserted and fixed to the housing 13 and is connected to a busbar 15 in a radial direction.

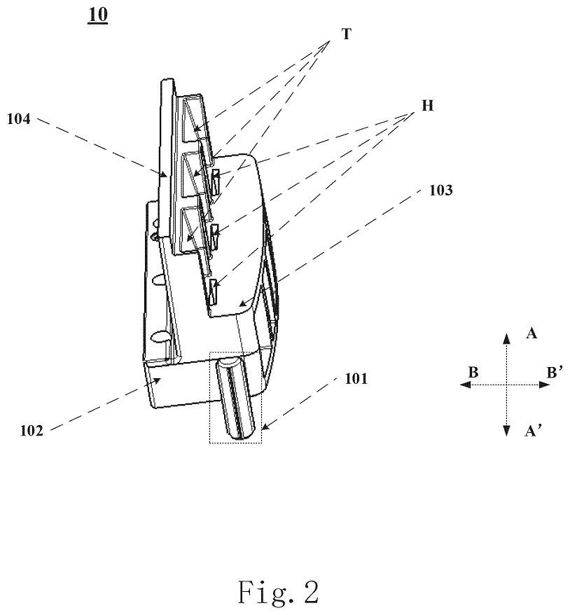

FIG. 2 is a schematic diagram of a connector 10 of the motor 100 provided by an example embodiment of the present application; as shown in FIG. 1 and FIG. 2, the connector 10 has at least two support portions 101, the at least two support portions 101 are respectively located on both sides of the connector 10, and are respectively connected and fixed to a side wall and a bottom surface of the housing 13 in an axial direction.

With the above structure, even if the busbar 15 generates a radial pulling force on the connector 10, since the support portions 101 support and fix the connector 10 from the sides and a part of the support portions 101 is inserted into the bottom of the housing to increase the length of the support portions 101, therefore, it is possible to prevent the connector 10 from being subjected to the force of the busbar 15 towards the radially inner side, thereby avoiding the connector 10 from tilting inward and improving the stability of the connector 10.

As shown in FIG. 2, the connector 10 also has a main body portion 102, a step portion 103, and an extension portion 104. The support portions 101 are fixed on both sides of the AA′ direction of the main body portion 102, that is, the radially outer sides of the side walls of the connector 10, and extend toward the bottom surface of the connector 10.

Therefore, it is possible to increase the torque by increasing the length of the force arm, and to prevent the connector 10 from tilting inward due to the radial pulling force. In some example embodiments, the step portion 103 is located on the same side of the support portions 101 in the BB′ direction and extends in a direction opposite to the support portions 101. The extension portion 104 is located at a position close to the B direction at the extending end of the step portion 103 and continues to extend in a direction opposite to the support portions 101. A through hole H is provided in the step portion 103, and a groove T matching the position of the through hole H is provided in the extension portion 104. Both the through hole H and the groove T are used for allowing the busbar 15 to pass through when the connector 10 is inserted and fixed to the housing 13. The specific manner will be described later.

In some example embodiments, the support portions 101 and the connector 10 are integrally provided portions of a single monolithic member, thereby improving the strength of the support portions 101 to the connector 10 and improving the stability of the connector 10.

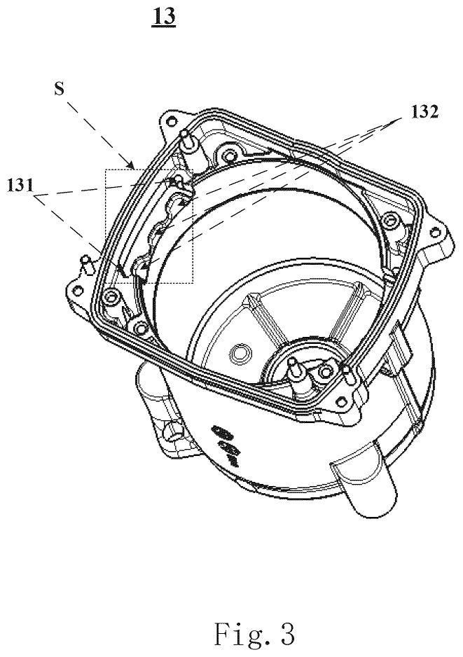

FIG. 3 is a schematic diagram of the housing 13 of the motor 100 provided by an example embodiment of the present application; as shown in FIG. 3, the connector 10 is inserted and fixed to the housing 13 at the position S of the housing 13, and the housing 13 has a reserved hole 131 and a recessed portion 132. The support portions 101 are fixed to the housing 13 by being inserted into the reserved holes 131.

In the above example embodiment, the reserved hole 131 is a cylindrical through hole, and its diameter is equal to or slightly larger than the diameter of the support portions 101. Specifically, in the above example embodiment, the connector 10 can be fixed to the housing 13 by interference fit, or the support portions 101 can also be fixed to the housing 13 by snapping, which is not limited in the present application.

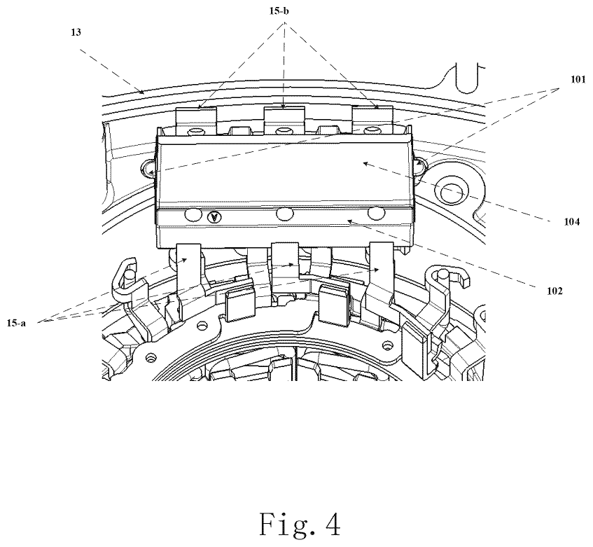

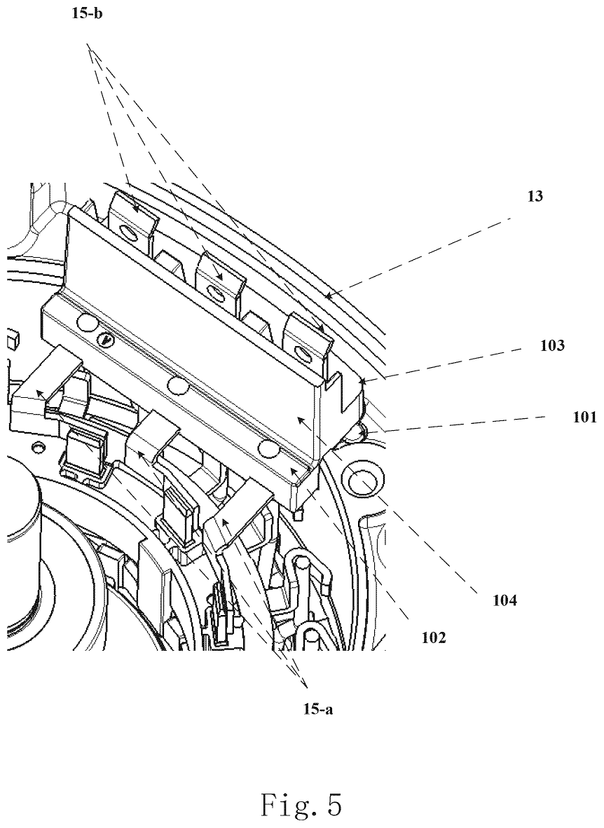

FIG. 4 is a schematic diagram of the connector 10 of the motor 100 provided by an example embodiment of the present application inserted into the housing 13; FIG. 5 is another schematic diagram of the connector 10 of the motor 100 provided by an example embodiment of the present application inserted into the housing 13; as shown in FIG. 4 and FIG. 5, after the support portions 101 are inserted into the reserved holes 131, the connector 10 is fixed to the housing 13.

At this time, the busbar 15-a inside the housing 13 can pass through the inside of the main body portion 102 of the connector 10, pass through the through hole H provided on the top of the step portion 103, and be held in the groove T of the extension portion 104, and the connector 10 and the busbar 15 are connected by clamping and welding. Therefore, a portion of the busbar 15-b can be connected to external electrical components. The above only exemplarily illustrates the relationship between the connector 10 and the busbar 15, but it is not limited thereto. For example, the busbar and the connector can also be integrally provided portions of a single monolithic member.

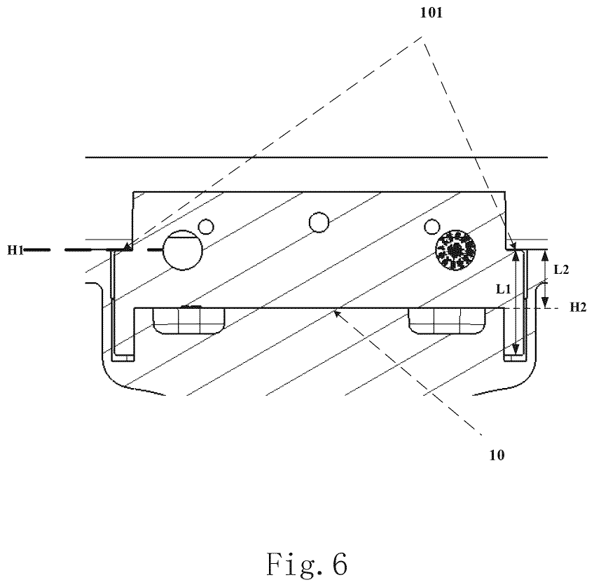

FIG. 6 is a cross-sectional view of a connector 10 of the motor 100 provided by an example embodiment of the present application; as shown in FIG. 6, the portion L2 in FIG. 6 shows the length of the side wall of the housing 13 in the axial direction. In some example embodiments, when the connector 10 is inserted into the housing 13, a part of the support portions 101 is connected and fixed to the side wall of the housing 13, and another part of the support portions 101 is further inserted into the housing 13 and extends inward to be connected and fixed to the bottom surface of the housing 13. As shown in FIG. 6, the length L1 of the support portion 101 is greater than or equal to the length L2 of the side wall of the housing 13. This can enhance the pulling force of the support portions 101, so that the connector 10 is not easily affected by the radial force of the busbar 15 and tilts inward.

In the above example embodiment, after the connector 10 is completely inserted into the housing 13, one end of the support portions 101 in the axial direction (the upper end shown in FIG. 6) is parallel to or higher than the upper end of the side wall of the housing 13, and the other end extends toward the bottom surface of the housing 13 and protrudes from the bottom of the connector 101.

FIG. 6 shows an example embodiment in which one end of the support portions 101 in the axial direction is parallel to the side wall of the housing 13. At this time, one end of the support portion 101 in the axial direction and the side wall of the housing 13 are both located at the position shown by H1, and the other end extends toward the bottom surface and protrudes from the bottom of the connector 101. The bottom of the connector 101 is located at the position shown by H2.

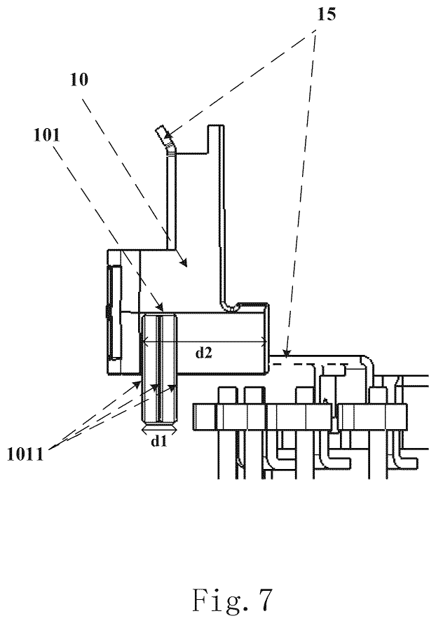

FIG. 7 is another schematic diagram of the connector 10 of the motor 100 provided by an example embodiment of the present application; as shown in FIG. 7, in some example embodiments, the diameter d1 of the support portions 101 is smaller than the planar length d2 of the support portions 101 (the length of the main body portion 102 in the radial direction), and d1 is greater than a predetermined value or ratio, for example, the diameter of the support portions can be 20% of the side wall length of the main body portion 102, that is, d1 >d2*20%. The above is described by taking 20% as an example, but the present application is not limited thereto. For example, the diameter d1 of the support portions 101 may be a predetermined value or other ratio. This can prevent the support portions 101 from being too thin and easily broken, and the support portions 101 are not too thick to affect the installation.

In some example embodiments, as shown in FIG. 7, the circumferential outer surface of the support portions 101 also has at least one rib 1011.

In the above example embodiment, the rib 1011 may be a protrusion protruding outward from t the circumferential outer surface of the support portion 101. After the support portions 101 are inserted into the housing 13, the rib 1011 can realize better interference fit between the support portions 101 and the housing 13, and improve the stability of the connector 10.

In the above example embodiment, FIG. 7 shows a structure in which the support portion 101 has three ribs 1011, but the present application is not limited thereto, and the number of ribs 1011 can be adjusted according to actual needs.

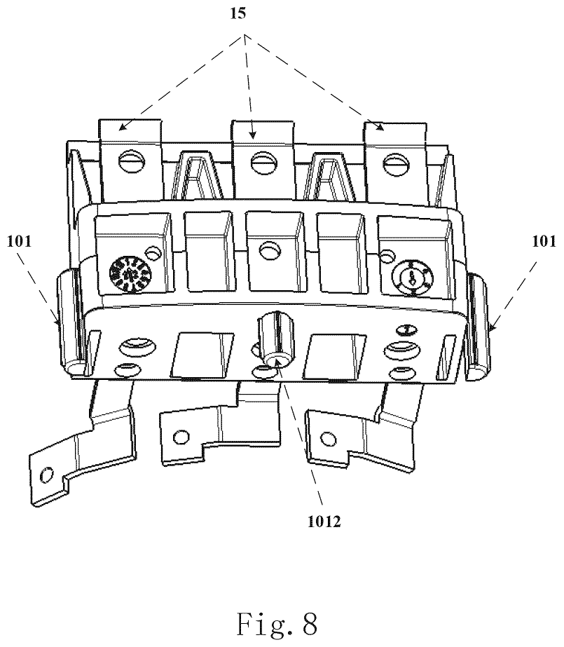

FIG. 8 is another schematic diagram of the connector 10 of the motor 100 provided by an example embodiment of the present application; as shown in FIG. 8, in some example embodiments, a partial cross-sectional shape of the support portions 101 inserted into the bottom surface of the housing 13 is semicircular. This arrangement enables the support portions 101 to be more easily inserted into the housing 13, and the semicircle has better stability, so that the connector 10 can be more stably fixed on the housing 13.

In some example embodiments, the cross-sectional shape of the support portions 101 may also be a D-shaped semicircle, which is not limited in the present application.

In some example embodiments, as shown in FIG. 8, the bottom of the connector 10 also has a bottom support portion 1012, and the bottom support portion 1012 is not on the same straight line as the support portions 101 located on both sides of the connector 10. That is, the bottom support portion 1012 and the support portions 101 form a triangular support on the bottom surface of the connector 10, which can make the stability of the connector 10 better.

The above only describes the structure of the motor related to the present application. For other structures of the motor, reference may be made to related technologies, and details are not described herein again.

With the motor provided by the example embodiments of the present application, the support portions can support and fix the connector from the sides, thereby preventing the connector from being subjected to the force of the busbar towards the radially inner side, thereby preventing the connector from tilting inward and improving the stability of the connector.

The example embodiments of the present application also provide an electrical product having the motor 100 described in the foregoing example embodiments. Since the structure of the motor 100 has been described in detail in the foregoing example embodiments, the content is incorporated herein, and the description is omitted here.

In the example embodiments of the present application, the electrical product may be any electrical equipment provided with a motor, for example, a motor for a vehicle.

The present application has been described above in conjunction with specific example embodiments, but those skilled in the art should be clear that these descriptions are exemplary and are not limitations on the protection scope of the present application. Those skilled in the art can make various variations and modifications to the present application according to the spirit and principle of the present application, and these variations and modifications are also within the scope of the present application.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A motor, comprising:
a rotor including a rotating shaft rotatable around a central axis;
a stator that is radially opposed to the rotor;
a housing that accommodates the rotor and the stator; and
a connector that is inserted and fixed to the housing and is connected to a busbar in a radial direction; wherein
the connector includes at least two support portions respectively located on two sides of the connector and respectively connected and fixed to a side wall and a bottom surface of the housing in an axial direction.

2. The motor according to claim 1, wherein the at least two support portions are located on a radially outer side of a side wall of the connector.

3. The motor according to claim 1, wherein a length of the at least two support portions in the axial direction is greater than or equal to a length of the side wall of the housing.

4. The motor according to claim 3, wherein one end of the at least two support portions in the axial direction is parallel to or higher than the side wall of the housing, and the other end extends toward the bottom surface of the housing and protrudes from a bottom of the connector.

5. The motor according to claim 1, wherein a diameter of the at least two support portions is greater than about 20% of a planar length where the at least two support portions are located.

6. The motor according to claim 1, wherein a cross-sectional shape of the portion of at least two support portions inserted into the bottom surface of the housing is semicircular.

7. The motor according to claim 1, wherein a circumferential outer surface of the at least two support portions includes at least one rib.

8. The motor according to claim 1, wherein the bottom of the connector also includes a bottom support portion that is not on a same straight line as the at least two support portions located on two sides of the connector.

9. The motor according to claim 1, wherein the support portions and the connector are integrally provided portions of a single monolithic structure.

10. An electrical product comprising the motor according to claim 1.
